(19) United States
(12) Patent Application Publication
(10) Pub. No.: US 2006/0248066 A1
(43) Pub. Date: Nov. 2, 2006

(54) System and method for optimizing search results through equivalent results collapsing

(75) Inventor: Brett D. Brewer, Sammamish, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/116,245

(22) Filed: Apr. 28, 2005

(51) Int. Cl. G06F 17/30

(52) U.S. Cl. 707/4

(57) ABSTRACT

A system and method are provided for optimizing a set of search results typically produced in response to a query. The method may include detecting whether two or more results access equivalent content and selecting a single user-preferred result from the two or more results that access equivalent content. The method may additionally include creating a set of search results for display to a user, the set of search results including the single user-preferred result and excluding any other result that accesses the equivalent content. The system may include a duplication detection mechanism for detecting any results that access equivalent content and a user-preferred result selection mechanism for selecting one of the results that accesses the equivalent content as a user-preferred result.

### CROSS-REFERENCE TO RELATED APPLICATIONS

None.

### STATEMENT REGARDING FEDERALLY SPONSORED RESEARCH OR DEVELOPMENT

None.

### TECHNICAL FIELD

Embodiments of the present invention relate to a system and method for optimizing search results. More particularly, embodiments of the present invention relate to a system and method for selecting a single result for display to a user when results are duplicative, while maintaining an optimal user experience.

### BACKGROUND OF THE INVENTION

Through the Internet and other networks, users have gained access to large amounts of information distributed over a large number of computers. In order to access the vast amounts of information, users typically implement a user browser to access a search engine. The search engine responds to an input user query by returning one or more sources of information available over the Internet or other network.

The search engine typically performs two functions including (1) finding matching information sources and (2) scoring the matching information sources to determine a display order. The search engines typically order or rank the results based on the similarity between the terms found in the accessed information sources to the terms input by the user. Results that show identical words and word order with the request input by the user are given a high rank and will be placed near the top of the list presented to the user.

Each information source contains a body of content and can be referenced by a locator such as a URL. Often, search engines locate multiple locators or results that access duplicative content. If a search engine obtains ten relevant results, three of those relevant results may lead to the same content. For example, www.ymca.net and www.ymca.net/index.isp access the same content with the former redirecting to the latter. In addition, www.ymca.com and www.ymca.com/index.jsp are also mirrors of www.ymca.net. To accurately measure whether a system returns optimal results for the query “ymca”, the system must determine whether these results lead to equivalent content.

As set forth above, one of the results may link directly with the content and the other results may go through a series of redirects to access the same content. Currently, most search engines will fail to detect and correct this duplication. Accordingly, users may access three different results to ultimately reach the same content three times. The failure to detect and filter out these duplicates results in frustration and time waste for the user. Search engines do a poor job of recognizing that content is repeated over and over again and of de-duplicating content from search engine results. This failure results in a sub-optimal user experience in which the user selects multiple search engine results, but receives the same content each time.

User satisfaction is a critical success factor for a search engine. Accordingly, a solution is needed that provides the user with the preferred result upon detecting duplicative results and preserves an optimal user experience. A solution is further needed that removes non-preferred results from the result set displayed to the user. A solution is further needed that allows for a greater depth of information to be viewed by the user on the first page of results.

### BRIEF SUMMARY OF THE INVENTION

Embodiments of the present invention include a method for optimizing a set of search results typically produced in response to a query. The method may include detecting whether two or more results access equivalent content and selecting a single user-preferred result from the two or more results that access equivalent content. The method may additionally include creating a set of search results for display to a user, the set of search results including the single user-preferred result and excluding any other results that accesses the equivalent content.

In an additional aspect, a system is provided for optimizing a set of search results that is produced in response to a query. The system includes a duplication detection mechanism for detecting any results that access equivalent content and a user-preferred result selection mechanism for selecting one of the results that accesses the equivalent content as a user-preferred result.

In yet a further aspect, a method is provided for optimizing a search result set including search results accessing equivalent content. The method may include determining a user-preferred result from the search results accessing equivalent content and selecting a navigation model result from the search results accessing the equivalent content. The method may additionally include displaying the user-preferred result to the user and upon selection of the user-preferred result, navigating to the content using the navigation model result.

### BRIEF DESCRIPTION OF THE DRAWINGS

The present invention is described in detail below with reference to the attached drawings figures, wherein:

FIG. 1 is a block diagram illustrating an overview of a system in accordance with an embodiment of the invention;

FIG. 2 is block diagram illustrating a computerized environment in which embodiments of the invention may be implemented;

FIG. 3 is a block diagram illustrating a result selection module in accordance with an embodiment of the invention;

FIG. 4 is a flow chart illustrating a method for obtaining a result set in accordance with an embodiment of the invention; and

FIG. 5 is a flow chart illustrating a method for filtering non-preferred duplicate results in accordance with an embodiment of the invention.

### DETAILED DESCRIPTION OF THE INVENTION

I. System Overview

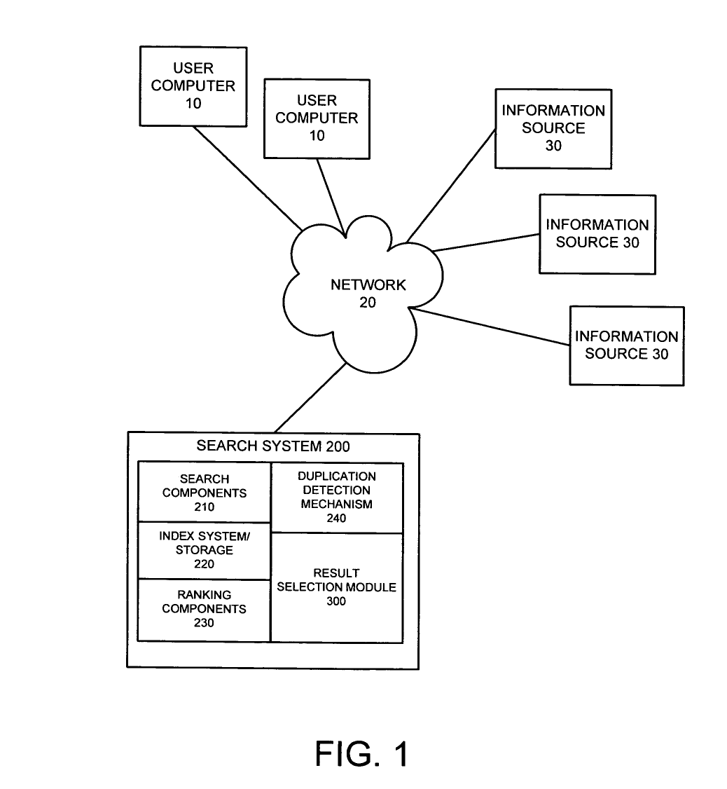

A system and method are provided for optimizing search results by detecting duplicate content and selecting a single result leading to the content for display to the user, while maintaining an optimal user experience. As illustrated in FIG. 1, a plurality of user computers 10 may be connected over a network 20 with a search system 200. The search system 200 may respond to a user query by searching a plurality of information sources 30. The information sources 30 may include content such as documents, images, web sites, etc. The search system 200 may include search components 210, an index/storage system 220, ranking components 230, a duplication detection mechanism 240, and a result selection module 300.

In operation, the search components 210 may include a crawler that traverses the information sources 30 and indexes and stores results in the index/storage system 220. The ranking components 230 may rank all located results in response to an input user query. The results storage components 220 may include a cache for recently stored results and an index system for storage of additional results. The duplication detection mechanism 240 is configured to detect results having duplicate content. As set forth above, different URLs or other locators may lead to the same content. With respect to the World Wide Web, since there are multiple ways to reference the same content, many information sources have mirrors, and URLs redirect to other URLs within and outside an original domain.

One technique for detecting duplicates is to use “shingleprints” as described in co-pending U.S. patent application Ser. No. 10/805,805 filed Mar. 22, 2004, hereby incorporated by reference. This technique samples data from each information source and abstracts the data to a 16-bit number, also called a shingleprint. In accordance with this technique, the 16-bit number is indexed for each result in the index system 220. If the shingleprints of two results are equal within a given tolerance, the results may be considered to lead to duplicate or equivalent content. Upon detection of duplicates based on the information contained in the index 220, which may be a shingleprint or other indicator, the result selection module 300 may select which result to display in order to best accommodate the users. Thus, by eliminating duplicate results, the result selection module 300 ensures that an optimum breadth of information is available to the user. The result selection module 300 may consider several factors in selecting which URL or locator to display to the user. Furthermore, despite the fact that one URL may be displayed to a user, the result selection module 300 may actually utilize a different URL to access or navigate to the content if a different URL will facilitate more rapid access.

Although the aforementioned components are shown as integrated with the search system 200, one or more of the components may exist as separate and discrete units or systems. The search engine 200 may include additional known components, omitted for simplicity.

II. Exemplary Operating Environment

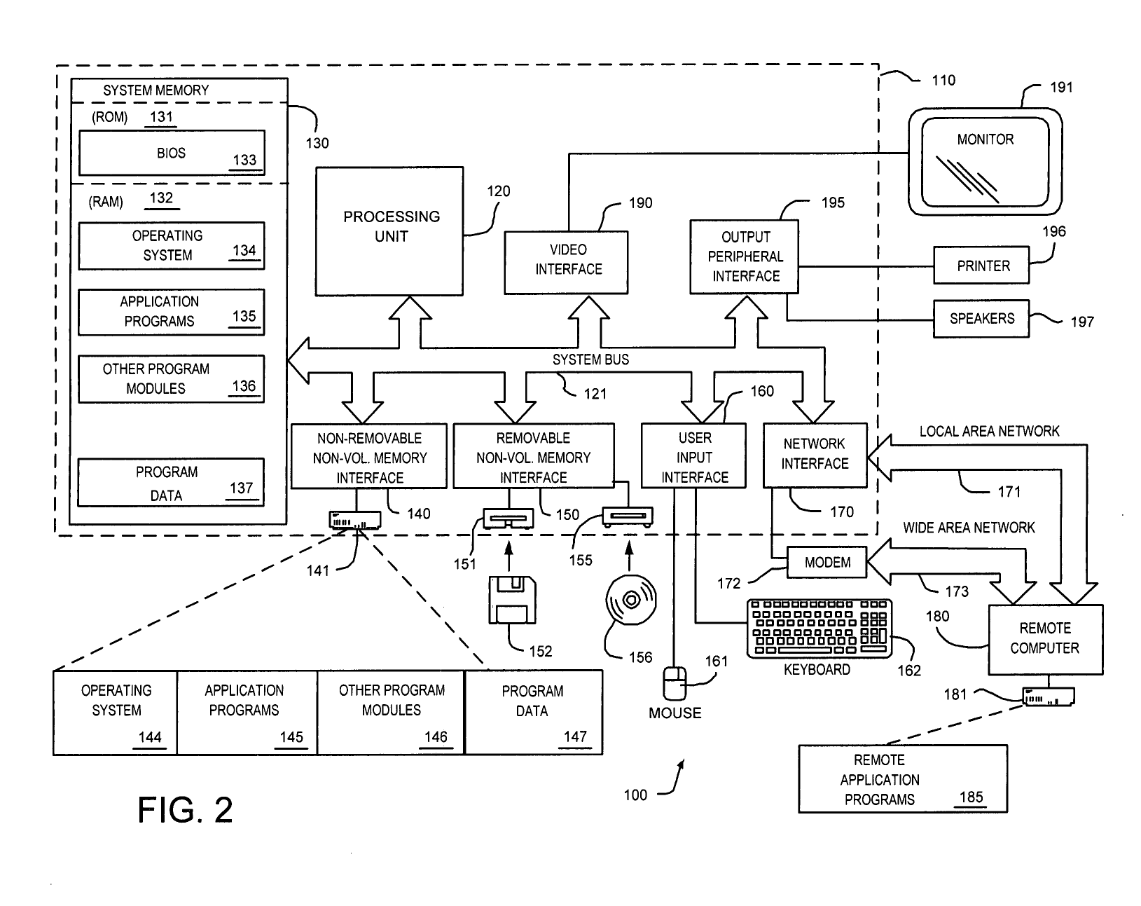

FIG. 2 illustrates an example of a suitable computing system environment 100 on which the system for optimizing search results by equivalent results collapsing may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

With reference to FIG. 2, the exemplary system 100 for implementing the invention includes a general purpose-computing device in the form of a computer 110 including a processing unit 120, a system memory 130, and a system bus 121 that couples various system components including the system memory to the processing unit 120.

Computer 110 typically includes a variety of computer readable media. By way of example, and not limitation, computer readable media may comprise computer storage media and communication media. The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/nonremovable, volatile/nonvolatile computer storage media. By way of example only, FIG. 2 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 in the present invention will operate in a networked environment using logical connections to one or more remote computers, such as a remote computer 180. The remote computer 180 may be a personal computer, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

III. System and Method of the Invention

As set forth above, FIG. 1 illustrates a system for delivering an optimal set of search results in accordance with an embodiment of the invention. The system for optimizing results by collapsing of duplicates may operate in conjunction with the search system 200, which is connected over the network 20 with user computers 10 and information sources 30. As described above with respect to FIG. 2, the network 20 may be one of any number of different types of networks such as the Internet.

As set forth above, the search engine 220 may search an index from the storage components 240 upon receiving a user query. A crawler within the search engine 220 may build the index by traversing the information sources 30 and indexing keywords pertaining to the traversed information sources 30. The search engine 220 may respond to a user query by matching terms in the user query with terms in the storage area 240. Ultimately, the search system 200 will provide the user with a result set.

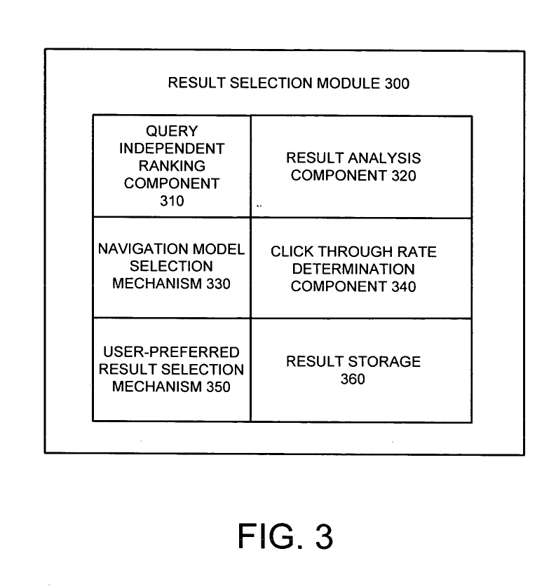

FIG. 3 is a block diagram illustrating the result selection module 300 in accordance with an embodiment of the invention. The result selection module 300 may include a query independent ranking component 310, a result analysis component 320, navigation model selection mechanism 330, a click through rate determination component 340, a user-preferred result selection mechanism 350, and result storage 360.

Once the duplication detection mechanism 240 detects a set of results leading to duplicate content, the result storage area 360 stores the set of locators in order to measure the relevance of various search algorithms. For example, an algorithm returning the user preferred result only would receive maximum relevance scores. Another algorithm that returns a sub-optimal result from a user perspective, or one that returns multiple mirrored results would receive a lower relevance score. These relevance measurement algorithms are implemented by components of the result selection module 300. Results that house the same content should be checked against for relevance measurement of the results.

As set forth above, www.ymca.net and www.ymca.net/index.jsp, www.ymca.com and www.ymca.com/index.js may all lead to the same information. After the duplication detection mechanism 240 detects that these results lead to duplicate content, it will store the results in the result storage area 360, but will not display them all. The components of the result selection module 300 will operate on the detected duplicates to select the best result to display to the user as well as the result that will serve as a navigation model to most quickly access the content. The result storage 360 may maintain all of the duplicates, while the user-preferred result selection mechanism 350 will only select one of the results to show to the user and use one of the results as a navigation model.

In operation, to facilitate the selection of a user-preferred result, the result analysis component 320 may analyze the components of the result locator. For example, when the result locator is a URL, the result analysis component 320 may analyze the extension. The extension “.com” appeals to users because users understand it.

The result analysis component 320 may also analyze result length. Users tend to prefer shorter URLs. In the above case, the user-preferred version of the URL may be www.ymca.com both because “.com” is more common than “.net” and because the www.ymca.com URL is shorter than the two “index.jsp” results. Thus the result analysis component 320 would recommend www.ymca.com as the user-preferred URL. Thus, the result selection module 300 would display the user-preferred version to the users in the search results. However, as set forth above, the link might actually go to www.ymca.com/index.js, which is selected by the navigation model selection mechanism 330 and is stored in the result storage area 360 in order to save the user a redirect. Accordingly the result storage area 360 links a front end user displayed result with a backend navigation result. The fastest result is typically the result that has the fewest re-directs. Furthermore, the result storage area 360 may store each different variation that leads to the duplicative content.

The result analysis component 320 may also analyze the URL as it relates to the keywords within the query. For example, the URL may contain words of the query and thus function as a document summary. Some results contain more keywords from the query than other results and are therefore better document summaries for the user.

The result analysis component 320 may determine the market by the country and/or language of the result locator. Users are typically more interested in results that are pertinent to their own country or market. Accordingly, the market determination component 330 would rank a local market result higher than a non-local market result.

The query independent ranking component 310 may analyze the popularity of the result by determining its rank based on how well linked it is to other sites. The click through rate determination component 340 may test the set of results or URLs to determine click-through variance and may select the result with the highest click-through rate. The click-through rate determination component 340 assumes that the high click-through rate indicates that users find the result satisfactory.

The navigation model selection mechanism 330 may select the navigation model for accessing the desired content. As set forth above, the navigation model may be a result or URL that accesses the desired content most expeditiously with the fewest re-directs.

The user-preferred result selection mechanism 350 receives input from the query independent ranking component 310, the result analysis component 320, and the click through determination component 340. Based on the received input, the user-preferred result selection mechanism 350 selects a user-preferred result.

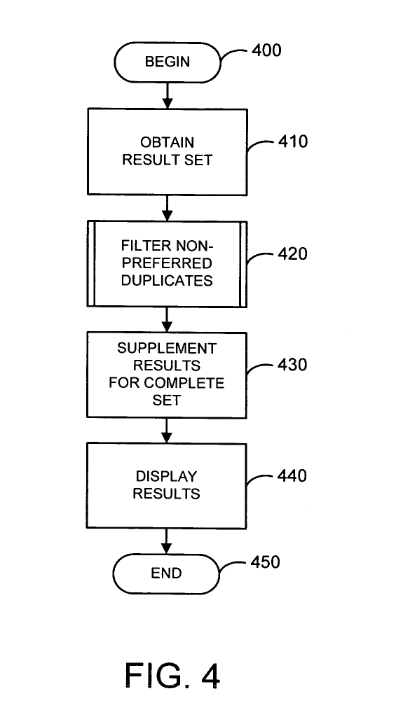

FIG. 4 illustrates a method for processing results in accordance with an embodiment of the invention. The method begins in step 400 and the search system 200 obtains a result set in step 410. In procedure 420, the result selection module 300 and duplication detection mechanism 240 filter out non-preferred duplicates using the system of FIG. 3 and determine which result to implement for user display and which to use as a navigation model. In step 430, the search system 200 supplements the result set, given the absence of duplicates, in order to obtain a complete set. In step 440, the search system 200 displays results and the method ends in step 450.

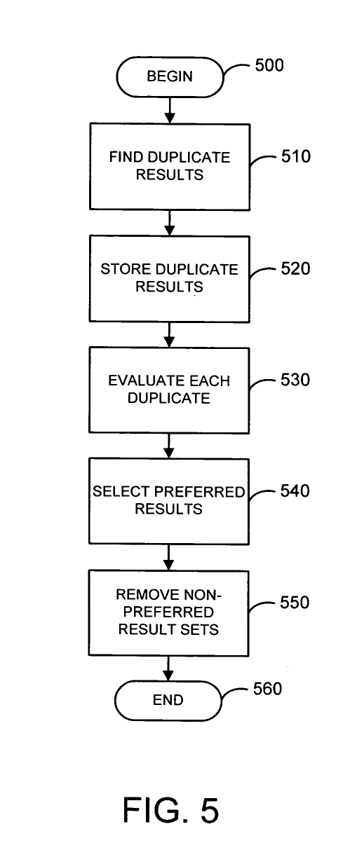

FIG. 5 illustrates a method for filtering out non-preferred duplicates in accordance with an embodiment of the invention. The method begins in step 500 and the duplication detection mechanism 240 finds duplicate results or defines a set of URLs as accessing equivalent content in step 510. In step 520, the search system 200 stores the duplicate results. In step 530, the result selection module 300 evaluates each stored duplicate by computing a relevance measurement to measure each given URL against an equivalence set. In step 540, the result selection module 300 selects a user-preferred result based on the evaluation. The navigation model selection mechanism determines the result most directly leading to the desired content and selects the navigation model based on that determination. The system integrates the previous results with index generation and the search user interface to show the user-preferred result to the user, but maintain the best user-experience result as the result to which the user will be routed. In some instances, the navigation model or best experience result and the user-preferred result may be the same. In step 550, the result selection module 300 removes any non-preferred duplicate results from the results set and the process ends in step 560. Finally, the search system 200 displays the results to the user, ensuring that duplicate content is not shown.

Accordingly, the above-described system defines a set of results as equivalent to the user. This definition may be achieved through the shingleprint technique. The system integrates with relevance measurement to measure a give result against an equivalence set. Furthermore, the system integrates with index generation and a search user interface to show the user-preferred URL to the user, but maintain the best user experience URL as a navigation model. Finally, the system integrates with the user interface to prevent showing duplicate content.

The system thus provides the user with the preferred version of the content, removing the others, allowing for a greater depth of content to be viewed by the user on a first page of results. The user therefore will encounter less frustration by avoiding viewing of identical content multiple times. The user is not required to proactively participate in the duplicate filtering and is able to gain the benefit by merely using the search system. Through repeated use, the system learns what version of the content is preferred most by users and relevance measurements become more accurate.

While particular embodiments of the invention have been illustrated and described in detail herein, it should be understood that various changes and modifications might be made to the invention without departing from the scope and intent of the invention. The embodiments described herein are intended in all respects to be illustrative rather than restrictive. Alternate embodiments will become apparent to those skilled in the art to which the present invention pertains without departing from its scope.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

What is claimed is:

1. A method for optimizing a set of search results, the set of search results produced in response to a query, the method comprising:
detecting whether two or more results access equivalent content;
selecting a single user-preferred result from the two or more results that access equivalent content; and
creating a set of search results for display to a user, the set of search results including the single user-preferred result and excluding any other result that accesses the equivalent content.

2. The method of claim 1, further comprising selecting a navigation model result from the two or more results that access equivalent content for navigating to the equivalent content.

3. The method of claim 1, further comprising analyzing the results that access equivalent content in order to select the single user-preferred result.

4. The method of claim 3, wherein analyzing the results comprises determining result length and assigning a high relevance to a shortest length result.

5. The method of claim 3, wherein analyzing the results comprises determining a result market and assigning a high relevance to a result having a market that matches a user market.

6. The method of claim 3, wherein analyzing the results comprises analyzing a URL extension and assigning relevance based on the URL extension.

7. The method of claim 3, further comprising assigning relevance to results based on a stored click-through rate of each result.

8. The method of claim 3, further comprising assigning relevance based on a query independent rank of each results.

9. The method of claim 1, further comprising replacing any excluded result with another result.

10. A system for optimizing a set of search results, the set of search results produced in response to a query, the system comprising:
a duplication detection mechanism for detecting any results that access equivalent content; and
a user-preferred result selection mechanism for selecting one of the results that accesses the equivalent content as a user-preferred result.

11. The system of claim 10, further comprising a navigation model selection mechanism for selecting a navigation model result from the results that access equivalent content for navigating to the equivalent content.

12. The system of claim 11, wherein the navigation model selection mechanism selects the navigation model result based on a fewest number of redirects.

13. The system of claim 10, further comprising a result analysis component for analyzing the results that access equivalent content in order to select the user-preferred result.

14. The system of claim 13, wherein the result analysis component analyzes a result length, a result market, and a result extension in order to select the user-preferred result.

15. The system of claim 13, further comprising a click through rate determination component for assigning relevance to results based on a stored click-through rate of each result.

16. The system of claim 13, further comprising a query independent ranking component for assigning relevance to each result based on a query independent rank.

17. A method for optimizing a search result set including search results accessing equivalent content, the method comprising:
determining a user-preferred result from the search results accessing equivalent content;
selecting a navigation model result from the search results accessing the equivalent content;
displaying the user-preferred result to the user; and
upon selection of the user preferred result, navigating to the content using the navigation model result.

18. The method of claim 17, further comprising selecting the navigation model result as a result having a fewest number of redirects.

19. The method of claim 17, further comprising analyzing the results that access equivalent content in order to select the single user-preferred result, wherein the analysis considers at least one of result length, result extension, and result market.

20. The method of claim 17, further comprising excluding any non-user preferred result from a displayed result set and replacing any excluded result with another result.
